(19) United States
(12) Patent Application Publication
(10) Pub. No.: US 2021/0352939 A1
(43) Pub. Date: Nov. 18, 2021

(54) Carbonated Beverages Comprising a Saponin and Methods of Making Said Beverages

(71) Applicant: CORN PRODUCTS DEVELOPMENT, INC, WESTCHESTER, IL (US)

(72) Inventors: FABIO BAX, JR., BRIDGEWATER, NJ (US); GIOVANNA PAIOSIN, BRIDGEWATER, NJ (US); ELVIS VERGINIO, BRIDGEWATER, NJ (US)

(21) Appl. No.: 17/044,110

(22) PCT Filed: Mar. 13, 2019
(86) PCT No.: PCT/US2019/022071

§ 371 Date: Sep. 30, 2020

Related U.S. Application Data
(60) Provisional application No. 62/643,020, filed on Mar. 14, 2018.

(51) Int. Cl. A23L 2/56; A23L 2/40; A23L 2/54

(52) U.S. Cl. CPC A23L 2/56; A23L 2/54; A23L 2/40

(57) ABSTRACT

Disclosed herein is one or more carbonated beverages comprising a saponin, and more particularly a saponin derived from the quillaja plant, and one or more methods of using reduced levels of carbon dioxide to make said carbonated beverage. Such beverages contain comparatively low levels of quillaja saponin for example illustrative embodiments include 0.1 to 40 ppm saponin. Also disclosed are beverage bases and beverage syrups useful for making a carbonated beverage

### CROSS-REFERENCE TO RELATED APPLICATIONS

This application claims the benefit of priority of U.S. Provisional Application No. 62/430,020, filed on Mar. 13, 2018, the contents of which are incorporated by reference herein in their entirety.

Disclosed herein are one or more carbonated beverages comprising a saponin, and more particularly a saponin derived from the quillaja plant.

The carbon dioxide in a carbonated beverage provides the effervescence experienced when such beverage is consumed. Often the level of effervescence consumers expect carbonated beverages to exhibit requires additional carbon dioxide to be added to the beverage during the manufacturing process. Carbon dioxide, however, can be an expensive ingredient. A significant amount of carbon dioxide is lost when a carbonated beverage container is opened. So, to maintain the desired level of carbon dioxide within a carbonated beverage, it is common to over carbonate the beverage, adding to cost.

Accordingly, there is a need in the art for lower cost methods to manufacture carbonated beverages that exhibit and retain the level of effervescence consumers expect of such carbonated beverages. This need is addressed by the carbonated beverages described herein, which beverages have levels of effervescence consumers expect of such beverages and can be manufactured with lower amounts of carbon dioxide than existing processes for making comparable carbonated beverages thereby reducing the manufacturing costs associated therewith.

### BRIEF DESCRIPTION OF THE DRAWINGS

All Figures presented herein are illustrative and not intended to limit the full scope of the claims.

FIG. 1 compares the size of surface bubbles for a carbonated beverage comprising quillaja saponins versus a carbonated beverage that does not comprise saponins.

One aspect this specification discloses is directed to a carbonated beverage comprising between 0.1 ppm and 40 ppm, about 1 ppm and 40 ppm, about 4 ppm and 30 ppm, or 4 ppm and 20 ppm of a saponin. Still other embodiments are directed to a carbonated beverage comprising a saponin, optionally from the quillaja plant, in an amount of less than 40 ppm, less than 20 ppm, less than 10 ppm, between about 1 ppm and 40 ppm, between about 5 ppm and 30 ppm, or between about 5 ppm and 20 ppm. Still yet other embodiments are directed to a carbonated beverage comprising a saponin in an amount of less than 0.004%, less than 0.002%, less than 0.001%, between 0.0001% and less than 0.004%, or between 0.0004% and 0.002% by weight of the beverage. One or more other embodiments are directed to a beverage base (e.g. a mixture containing all ingredients in a beverage except sweetener, water, and carbon dioxide), comprising a saponin in an effective amount to produce a carbonated beverage comprising less than 40 ppm, less than 20 ppm, less than 10 ppm, between about 1 and 40 ppm, between about 4 and 30 ppm, or between about 4 ppm and 20 ppm. Still other embodiments are directed to a beverage base comprising a saponin in an effective amount to produce a carbonated beverage comprising less than 0.004%, less than 0.002%, less than 0.001%, between 0.0001% and less than 0.004%, or between 0.0004% and 0.002% saponin by weight of the beverage. Still further embodiments are directed to a beverage syrup (e.g. a mixture of sweetener and water) comprising a saponin in effective amount to produce a carbonated beverage comprising less than 40 ppm, less than 20 ppm, less than 10 ppm, between about 1 and 40 ppm, between about 4 and 30 ppm, or between about 4 ppm and 20 ppm. Even still further embodiments are directed to a beverage syrup (e.g. a mixture of sweetener and water) comprising a saponin in effective amount to produce a carbonated beverage comprising less than 0.004%, less than 0.002%, less than 0.001%, between 0.0001% and less than 0.004%, or between 0.0004% and 0.002% saponin by weight of the beverage.

Still other embodiments are directed to a carbonated beverage comprising a saponin, optionally from a quillaja plant and added carbon dioxide. In some embodiments, the carbonated beverage comprising said saponin comprises a lower amount of added carbon dioxide than a saponin-free comparative carbonated beverage (where a saponin-free comparative carbonated beverage comprises no added saponins). In still other embodiments, the carbonated beverage comprising said saponin comprises a lower amount of added carbon dioxide than a saponin-free comparative carbonated beverage, and has a comparable or better effervescence than a saponin-free comparative carbonated beverage when said beverages are tested in a triangle testing assay or ranking testing assay as set forth in Examples 2 and 3. In at least one embodiment, the carbonated beverage comprises a saponin and added carbon dioxide in an amount of up to 5%, up to 10%, up to 15%, up to 17.5%, or up to 20% less than the saponin-free comparative carbonated beverage. In yet another embodiment, the carbonated beverage comprises a saponin and added carbon dioxide in an amount of between 5% and 20%, 7% and 17.5%, 6.5% and 14.5%, or between 7% and 15%, or about 6.5% or about 14.5% less than a saponin-free comparative carbonated beverage. In one or more embodiments, the carbonated beverage is a cola, a ginger ale, a tonic water, a sparkling water, a fruit flavored beverage (for example, but not limited to, lemon, orange or other citrus flavored, or grape flavored beverage), or a cream flavored beverage. In at least one embodiment, the carbonated beverage comprising a saponin and added carbon dioxide in an amount of up to 5%, up to 10%, up to 15%, up to 17.5%, or up to 20% less, or between 5% and 20%, between 7% and 17.5%, between 6.5% and 14.5%, or between 7% and 15% less, or about 6.5% or 14.5% less carbon dioxide than the saponin-free comparative carbonated beverage has comparable or better effervescence than a saponin-free comparative carbonated beverage when said beverages are tested in a triangle testing assay or ranking testing assay as set forth in Examples 2 and 3.

In the beverage industry it is common to use gas volumes to measure the amount of carbon dioxide in a beverage. Within this specification one gas volume is ratio of gas dissolved water at 15.6° C. (60° F.) and one atmosphere of pressure. In various embodiments, the carbonated beverage described in this specification is a cola, ginger ale, tonic water, or sparkling water, and includes saponin and carbon dioxide added in an amount of less than 3, between about 2 and less than about 3, or between 2.2 and 2.8 gas volumes. In other embodiments, a carbonated beverage described in this specification is a fruit or cream flavored beverage and includes a saponin and carbon dioxide added in an amount of less than about 2.5, between about 1.5 and less than about 2.5, or between 2.0 and 2.4 gas volumes.

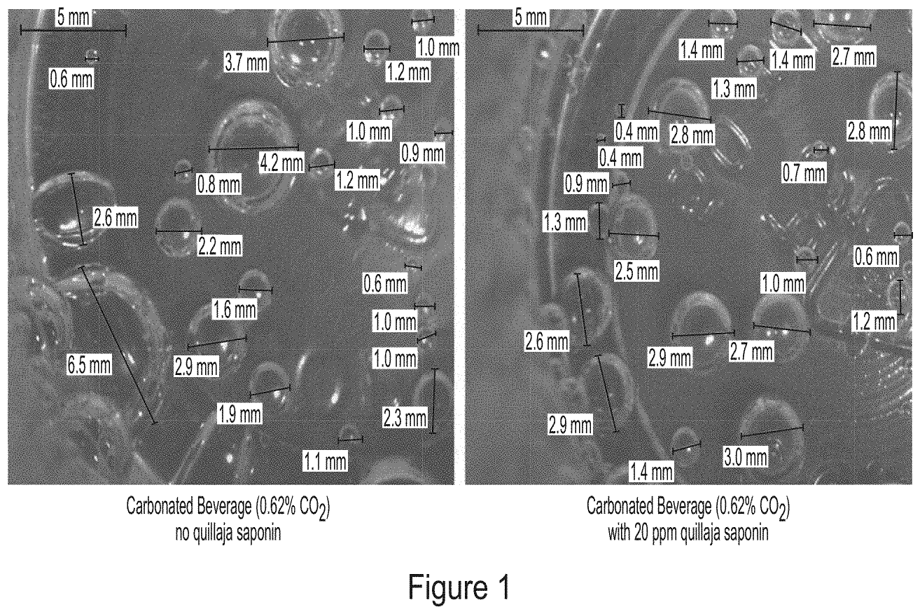

With reference to FIG. 1, it is seen that a carbonated beverage (0.62% carbon dioxide at room temperature) comprising quillaja saponins had surface bubbles ranging in size from 0.4 to 3.0 mm whereas a carbonated beverage (0.62% carbon dioxide at room temperature) without quillaja saponins had surface bubbles ranging from 0.6 to 6.5 mm. It is also seen that generally the beverage comprising quillaja had smaller surface bubbles than the beverage that does not comprise quillaja.

In various embodiments disclosed in this specification, the saponin is from a quillaja plant. In any embodiment, the quillaja extract is a Type I (INS 999i; CAS #68990-67-0) extract or Type II (INS 999ii; CAS #68990-67-0) extract. In yet other embodiments, the quillaja saponins are monomeric saponins ranging in molecular weight from between 1,800 and 2,300 kg/mol (consistent with a triterpene with 8-10 monosaccharide residues). The quillaja saponins may be in liquid or solid form and may be provided as quillaja extracts or purified quillaja saponins. In one or more embodiments a quillaja extract comprises at least 20%, about 23%, between 20% and 26%, or between 65% and 90% quillaja saponins by weight (db). In various embodiments a beverage, beverage syrup or beverage base comprises an effective amount of quillaja extract to provide less than 40 ppm, less than 20 ppm, less than 10 ppm, between about 1 ppm and 40 ppm, between 4 ppm and 30 ppm or between about 4 and 20 ppm quillaja by weight to said beverage. In various other embodiments. In various other embodiments a beverage, beverage base, or beverage syrup comprises an effective amount of quillaja extract to provide less than 0.004%, less than 0.002%, less than 0.001%, between 0.0001% and less than 0.004%, or between 0.0004% and 0.002% saponin by weight of the beverage.

In another aspect this specification discloses using a saponin, for example a quillaja saponin, to reduce the amount of carbon dioxide that is added to a carbonated beverage to achieve the desired level of effervescence. In one embodiment, a saponin is used to reduce the amount of carbon dioxide added to a beverage by adding the saponin to the beverage prior to carbonization in an amount of less than 40 ppm, less than 20 ppm, less than 10 ppm, between 0.1 ppm and 40 ppm, about 1 ppm and 40 ppm, between 4 ppm and 30 ppm or between about 4 and 20 ppm. In another embodiment, a saponin is used to reduce the amount of carbon dioxide added to a beverage by adding the saponin to the beverage prior to carbonization in an amount of less than 0.004%, 0.002%, or 0.001%, or between 0.0001% and less than 0.004% or between 0.0004% and 0.002% by weight of the beverage. In another embodiment, an effective amount of saponin is used in a beverage base or beverage syrup to produce a carbonated beverage comprising less than 40 ppm, less than 20 ppm, less than 10 ppm, between about 1 and 40 ppm, between about 4 and 30 ppm, or between about 4 and 20 ppm. In still another embodiment, an effective amount of saponin is used in a beverage base or beverage syrup to produce a carbonated beverage comprising less than 0.004%, 0.002%, or 0.001%, or between 0.0001% and less than 0.004% or between 0.0004% and 0.002% by weight of said beverage. In another embodiment, the saponin is used to reduce the amount of added carbon dioxide that is added to the beverage such that the carbonated beverage comprises up to 5% less, up to 10% less, up to 15% less, up to 17.5% less, up to 20% less, between 5% and 20%, between 7% and 17.5%,between 6.5% and 14.5%, between 7% and 15% less, or about 6.5% less carbon dioxide than a saponin-free comparative carbonated beverage. In various embodiments a saponin is used to reduce the amount of carbon dioxide added to a cola, ginger ale, tonic water, or sparkling water, such that less than 3, between about 2 and less than about 3, or between 2.2 and 2.8 gas volumes of carbon dioxide is added to said cola, ginger ale, tonic water, or sparkling water. In various other embodiments a saponin is used to reduce the amount of carbon dioxide added to a fruit flavored or cream flavored beverage such that less than about 2.5, between about 1.5 and less than about 2.5, or between 2.0 and 2.4 gas volumes of carbon dioxide is added to said fruit flavored or cream flavored beverage. In yet still other embodiments an effective amount of saponin used to produce a carbonated beverage that has comparable or better effervescence than a saponin-free comparative carbonated beverage when said beverages are tested in a triangle testing assay or ranking testing assay as set forth in Examples 2 and 3.

In another aspect this specification discloses methods for making a carbonated beverage comprising adding a saponin, for example a quillaja saponin, to the beverage in an amount of less than 40 ppm, less than 20 ppm, less than 10 ppm, between 0.1 ppm and 40 ppm, about 1 and 40 ppm, between 4 ppm, between 4 ppm and 30 ppm or and 20 ppm. In one embodiment a method for making a carbonated beverage comprises adding a saponin is to the beverage in an amount of less than 0.004%, less than 0.002%, less than 0.001%, between 0.0001% and less than 0.004%, or between 0.0004% and 0.002% weight of the beverage. In another embodiment a method for making a carbonated beverage comprises adding a saponin to the beverages prior to adding carbon dioxide. In another embodiment a method for making a carbonated beverage comprises adding a saponin to a beverage base, (e.g. a mixture comprising all ingredients of a beverage except water, sweetener and carbon dioxide) In at least one embodiment a method for making a carbonated beverage comprises adding a saponin to a beverage base in an effective amount such that when the base is mixed to form a beverage the beverage comprises less than 40 ppm, less than 20 ppm, less than 10 ppm, between about 1 and 40 ppm, between about 4 ppm and 30 ppm, or 4 ppm and 20 ppm saponin. In still another embodiment a method of making a carbonated beverage comprises adding a saponin to a beverage base in an effective amount such when the base is mixed to form a beverage the beverage comprises less than 0.004%, less than 0.002%, less than 0.001%, between 0.0001% and less than 0.004%, or between 0.0004% and 0.002% saponin by weight of the beverage. In still another embodiment a method for making a carbonated beverage comprises adding a saponin to a beverage syrup (e.g. a mixture of sweetener and water). In yet still another embodiment a method for making a carbonated beverage comprises adding a saponin to a beverage syrup in an effective amount such that when the syrup is mixed to form a beverage the beverage comprises less than 40 ppm, less than 20 ppm, less than 10 ppm, between about 1 and 40 ppm, between 4 ppm and 30 ppm, or between 4 ppm and 20 ppm. In even still another embodiment a method for making a carbonated beverage comprises adding a saponin to a beverage syrup in an effective amount such that when the syrup is mixed to form a beverage the beverage comprises less than 0.004%, less than 0.002%, less than 0.001%, between 0.0001% and less than 0.004%, between 0.0004% and 0.003%, or between 0.0004% and 0.002% saponin by weight of the beverage. In at least one embodiment a carbonated beverage is made by a method comprising mixing, in any order a beverage base, a sweetener, water and a saponin to form a mixture of base, sweetener, water, and saponin followed by adding carbon dioxide to said mixture. In one or more embodiments a method of making a carbonated beverage comprises mixing water and beverage base in a ratio of 5 to 1 ratio (water to base). In various embodiments a method of making of a carbonated beverage comprises adding carbon dioxide to a beverage using standard methods used in the carbonated beverage bottling industry. In at least one embodiment a method of making a carbonated beverage comprises adding carbon dioxide to a beverage using a filling machine (e.g. Armfield FT102A automated carbonator and filler) which regulates temperature and pressure to achieve a target gas volume of carbon dioxide added to a beverage. In at least one embodiment a method for making a carbonated beverage comprises adding carbon dioxide to a beverage at a temperature of about 10° C. and pressure of about 30 psi. In another embodiment a method for making a carbonated beverage comprises cooling a beverage prior adding carbon dioxide using a refrigeration process separate from a filling machine. In one or more embodiments a method of making a carbonated beverage comprises adding carbon dioxide to a beverage comprising a saponin in amount up to 5%, up to 10% less, up to 15% less, up to 17.5% less, up to 20% less, between 5% and 20%, between 7% and 17.5 between 6.5% and 14.5% or between 7% and 15% less. In various embodiments a method for making a cola, ginger ale, tonic water or sparkling water comprises adding less than 3, between about 2 and less than about 3, or between 2.2 and 2.8 gas volume of carbon dioxide to the beverage. In various other embodiments a method for making a fruit flavored or cream flavored carbonated beverage comprises adding less than about 2.5, between about 1.5 and less than about 2.5, or between 2.0 and 2.4 gas volumes of carbon dioxide to the beverage.

The invention is further described by the following illustrative aspects which are intended to be non-limiting.

In a first aspect the technology pertains to a carbonated beverage comprising between 0.1 and 40 ppm, about 1 and 40 ppm, about 4 and 30 ppm, or 4 and 20 ppm of a saponin.

In a second aspect the technology pertains to the carbonated beverage of the first aspect, wherein said beverage further comprises added carbon dioxide.

In a third aspect the technology pertains to the carbonated beverage of the first or second aspects, wherein said beverage is a cola, ginger ale, tonic water, or sparkling water, and comprises added carbon dioxide in an amount of less than 3, between about 2 and less than about 3, or between 2.2 and 2.8 gas volumes.

In a fourth aspect the technology pertains to the carbonated beverage of the first or second aspects, wherein said beverage is a fruit or cream flavored beverage and comprises added carbon dioxide in an amount of less than about 2.5, between about 1.5 and less than about 2.5, or between 2.0 and 2.4 gas volumes.

In a fifth aspect the technology pertains to the carbonated beverage of any of preceding aspects, wherein said beverage comprises (i) a lower amount of added carbon dioxide than a saponin-free comparative carbonated beverage, and (ii) comparable or better effervescence than a saponin-free comparative carbonated beverage when said beverages are tested in a triangle testing assay or ranking testing assay as set forth in Examples 2 and 3.

In a sixth aspect the technology pertains to the carbonated beverage of any of the preceding aspects wherein said beverage has between 5% and 20% or 7% and 15% less carbon dioxide than the test carbonated beverage having no saponin.

In a seventh aspect the technology pertains to the carbonated beverage of any of the preceding aspects the beverage of any of the preceding claims where the saponin is from a quillaj a plant.

In an eighth aspect the technology pertains to the use of a saponin to make a carbonated beverage having reduced carbon dioxide wherein said beverage comprises from between 5% and 20% or 7% and 15% less carbon dioxide than the beverage contains when no saponin is used to make said beverage, wherein the saponin is optionally from a quillaja plant.

In a ninth aspect the present technology pertains to a method of making a carbonated beverage according to any preceding aspect.

In a tenth aspect the present technology pertains to a method of making a carbonated beverage comprising: mixing a beverage base and a saponin, in an amount such that the beverage comprises between 0.1 and 40 ppm, about 1 and 40 ppm, about 4 and 30 ppm, or about 4 and 20 ppm of a saponin.

In an eleventh aspect the present technology pertains the method of the tenth aspect further comprising adding carbon dioxide to the beverage.

In a twelfth aspect the technology pertains to the method of the tenth or eleventh aspects, wherein the beverage is a cola, ginger ale, tonic water, or sparkling water and said beverage base is mixed with less than 3 or between 2.0 and 2.9 gas volumes of the added carbon dioxide.

In a thirteenth aspect the technology pertains to the method of the tenth or eleventh aspects, wherein the beverage is a fruit or cream flavored beverage and said beverage base is mixed with less than 2.5 or between 1.5 and 2.5 gas volumes of the added carbon dioxide.

In a fourteenth aspect the technology pertains to the method of the one of the tenth to thirteenth aspects, wherein the beverage base comprises at least one flavored oil and said beverage base is further mixed with water.

In a fifteenth aspect the technology pertains to the method of any one of the tenth to fourteenth aspects, wherein the saponin is first mixed with a beverage syrup comprising a sweetener and water, and said syrup is then mixed with the beverage base to form a beverage base comprising the saponin.

In a sixteenth aspect the technology pertains to the method of any one of the tenth to fifteenth aspects, wherein said method produces a carbonated beverage having (i) a lower amount of added carbon dioxide than a saponin-free comparative carbonated beverage, and (ii) comparable or better effervescence than said saponin-free comparative carbonated beverage when said beverages are tested in a triangle testing or ranking testing assay as set forth in Examples 2 and 3.

In a seventeenth aspect the technology pertains to the method of any one of the tenth to sixteenth aspects, wherein said beverage has between 5% and 20% or 7% and 15% less carbon dioxide than the saponin-free comparative carbonated beverage.

In an eighteenth aspect the technology pertains to the method of any one of the ninth to seventeenth aspects, wherein the saponin is derived from quillaja.

In a nineteenth aspect the technology pertains to a beverage base for use in a beverage, wherein said base comprises at least one flavored oil and an effective amount of a saponin derived from quillaja plant such that said beverage comprises between 0.1 and 40 ppm, about 1 and 40 ppm, about 5 and 30 ppm, or about 5 and 20 ppm when said base is added to the beverage.

In a twentieth aspect the technology pertains to a beverage syrup for use in a beverage, wherein said syrup comprises a sweetener, water and an effective amount of a saponin derived from quillaja plant such that said beverage comprises between 0.1 and 40 ppm, about 1 and 40 ppm, about 5 and 30 ppm, or about 5 and 20 ppm saponin when said syrup is added to the beverage.

The invention is further described by way of the following examples which are not intended to be limiting in any way. One of ordinary skill in the art would recognize that variations could be made which would be within the scope of the claims.

### EXAMPLES 1

### Materials and Procedures

The sensory perception of low carbon dioxide and standard carbon dioxide were evaluated using discriminative testing by a consumer panel.

Two test samples were made, one with a 6.5% reduction in carbon dioxide versus control and one with a 14.5% reduction in carbon dioxide versus control. Test samples were made by carbonating a local brand (Brazil) of still water (Bioleve Lindoyo sin gas).

Control Sample

The control was a local brand (Brazil) of artificially carbonated sparkling water (Bioleve Lindoyo com gás)

Test samples were carbonated using an Armfield FT102A automated carbonator and filler. Carbonated water was made as follows: 10 L each of Sample 1 and Sample 2 still waters containing 20 ppm quillaja saponin extract (23% saponin content, db). The characteristics of Control, Sample 1 and Sample 2 as obtained by the carbonator are listed in Table 1.

TABLE 1
Parameters of Sample and Control Beverages

| | Control | Sample 1 | Sample 2 |
|---|---|---|---|
| Temperature (° C.) | 1.0 | 1.0 | 1.0 |
| Pressure (psi) | 16.0 | 14.0 | 11.5 |
| CO₂ content (% w/w) | 0.62 | 0.58 | 0.53 |
| CO₂ content (gas volumes) | 3.4 | 3.1 | 2.8 |
| % CO₂ reduction vs. control | — | 6.5 | 14.5 |

Water was poured into 250 mL PET bottles after desired carbon dioxide content was attained.

### Sensory Testing

Discriminative testing was used to determine if there was a perceived difference between Samples and Control. Statistical analysis was performed to verify that any perceived differences recorded were statistically significant.

Sensory testing was conducted by an untrained panel. The method evaluated the perceived carbonation over a typical drinking experience, i.e. just after first package opening and depressurization (approx. 3-5 minutes). Samples were tested in sensory booths in a room with white fluorescent lighting. Samples were served at between 4 and 6° C. in 50 mL plastic cups coded with a three-digit code. Panelists entered their ratings on computers running Compusense® five software, which made the statistical calculations. Samples were presented in monadic, randomized and balanced fashion. During testing panelists were provided palate cleansers of water and unsalted crackers.

Two testing procedures were used, a triangular testing assay and a ranking testing assay (using Freidman's test and Fisher LSD for statistical analysis.) For triangle testing assays, panelists received the three coded samples and were asked to identify the odd sample. Statistical significance is achieved with a p value less than 0.05. Within the model, for a panel of 55, statistical significance at a confidence level of 95% is achieved when at least 25 panelists perceived a difference between the samples. Panelists perceiving an odd sample were further polled to describe the perceived difference.

For ranking testing assays panelists were asked to rank the three samples on a scale of 1 to 3. Samples rated 1 were perceived to have the highest carbonation. Samples rated 3 were perceived to have the lowest carbonation level. Samples rated 2 were perceived to have an intermediate carbonation level. For Freidman's Test analysis, rankings were added and the different raw ranking score was assessed for statistical significance at p value less than 0.05. If a statistically significant difference was found, Fisher's LSD was applied to determine if statistically significant differences could be seen among the differences between the Control, Sample 1 and Sample 2. Again statistical significance was measured at p less than 0.05.

### EXAMPLE 2

### Triangle Test Assay Results

Example 2a—Sample 1 vs. Control: of the 55 panelists, 27 perceived no odd sample, and 28 selected an odd sample resulting in a confidence interval of 0.995 and a significance value of p=0.005 showing a statistically significant difference was perceived between Sample 1 and the control. The comments provided characterizing the differences are listed in Table 2.

TABLE 2
Triangle Test Assay Panelist Comments
Control vs. Sample 1

| Comment | Control (n = 17) | Sample 1 (n = 11) |
|---|---|---|
| Flavor/taste | 12 | 6 |
| It has less gas | 5 | 1 |
| It has more gas | 1 | 5 |
| Other | 1 | 0 |

Example 2b Sample 1 vs. Control: of the 55 panelists, 28 perceived no odd sample, and 27 selected an odd sample resulting in a confidence interval of 0.989 and a significance value of p=0.011 showing a statistically significant difference was perceived between Sample 1 and the control. The comments provided characterizing the differences are listed in Table 3.

TABLE 3
Traingle Test Assay Panelist Comments
Control vs. Sample 2

| Comment | Control (n = 13) | Sample 2 (n = 14) |
|---|---|---|
| Flavor/taste | 8 | 9 |
| It has less gas | 4 | 1 |
| It has more gas | 1 | 7 |
| Other | 1 | 0 |

### Example 3

### Results Ranking Test Assay

As shown in Table 4 the Control had a raw ranking score (sum of all rankings 1, 2, or 3) of 136. Sample 1 had a raw ranking of 91, and Sample 2 had a raw ranking of 103. The absolute difference of the samples was statistically significant to at a confidence level of 100%. Fisher LSD analysis found that the ranking difference between Sample 1 and Sample 2 was not statistically significant, and so both were placed in group A. Fisher LSD analysis further found that the difference between Sample 1 and the Control and between Sample 2 and the Control was statically significant. So the Control was placed in group B. These results are summarized in Table 4.

TABLE 4
Ranking Test Assay Results

| Ranking test | Total rank score | Fisher LSD groupings |
|---|---|---|
| Control | 136 | B |
| Sample 1 | 91 | A |
| Sample 2 | 103 | A |
| Significance (p-value) | 0.000 | |

1. A carbonated beverage comprising between 0.1 and 40 ppm, about 1 and 40 ppm, about 4 and 30 ppm, or 4 and 20 ppm of a saponin.

2. The carbonated beverage of claim 1, wherein said beverage is a cola, ginger ale, tonic water, or sparkling water, and comprises added carbon dioxide in an amount of less than 3, between about 2 and less than about 3, or between 2.2 and 2.8 gas volumes.

3. The carbonated beverage of claim 1, wherein said beverage is a fruit or cream flavored beverage and comprises added carbon dioxide in an amount of less than about 2.5, between about 1.5 and less than about 2.5, or between 2.0 and 2.4 gas volumes.

4. The beverage of claim 1 wherein the saponin is from a quillaja plant.

5. A method of making a carbonated beverage comprising:
mixing a beverage base and a saponin, in an amount such that the beverage comprises between 0.1 and 40 ppm, about 1 and 40 ppm, about 4 and 30 ppm, or about 4 and 20 ppm of a saponin.

6. The method of claim 5 further comprising adding carbon dioxide to the beverage.

7. The method of either claim 5 wherein the beverage is a cola, ginger ale, tonic water, or sparkling water and said beverage base is mixed with less than 3 or between 2.0 and 2.9 gas volumes carbon dioxide.

8. The method of either claim 5 wherein the beverage is a fruit or cream flavored beverage and said beverage base is mixed with less than 2.5 or between 1.5 and 2.5 gas volumes carbon dioxide.

9. The method of any one of claim 5 wherein the beverage base comprises at least one flavored oil and said beverage base is further mixed with water.

10. The method of any one of claim 5 wherein the saponin is first mixed with a beverage syrup comprising a sweetener and water, and said syrup is then mixed with the beverage base to form a beverage base comprising the saponin.

11. The method of any one of claim 5 wherein the saponin is derived from quillaja.

12. (canceled)

13. A beverage syrup for use in a beverage, wherein said syrup comprises a sweetener, water and an effective amount of a saponin derived from quillaja plant such that said beverage comprises between 0.1 and 40 ppm, about 1 and 40 ppm, about 5 and 30 ppm, or about 5 and 20 ppm saponin when said syrup is added to the beverage.
